(19) United States
(12) Patent Application Publication
(10) Pub. No.: US 2024/0354838 A1
(43) Pub. Date: Oct. 24, 2024

(54) PRESCRIPTION LOCATION SYSTEM AND METHOD OF USE

(71) Applicant: Kirat Shahiwala, Parker, TX (US)

(72) Inventor: Kirat Shahiwala, Parker, TX (US)

(21) Appl. No.: 16/817,531

(22) Filed: Mar. 12, 2020

Related U.S. Application Data
(60) Provisional application No. 62/817,021, filed on Mar. 12, 2019.

(51) Int. Cl. G06Q 30/08; G06Q 30/0283

(52) U.S. Cl. CPC G06Q 30/08; G06Q 30/0283

(57) ABSTRACT

A prescription location system allows individuals to find lower cost on prescription medications. The power of independent pharmacies and other underutilized sources is made available to individuals through a portal. The portal accepts data about the needed medications and conditions then allows the independent pharmacies to bid on fulfilling these needs.

### BACKGROUND

### 1. Field of the Invention

The present invention relates generally to commerce systems, and more specifically, to a prescription location system of providing cost data to the consumer from multiple sources including independent pharmacies.

### 2. Description of Related Art

Commerce systems are well known in the art and are effective means to transact goods and services from one party to another. For example, FIG. 1 depicts a conventional medication purchasing method 101 having a consumer 103 who receives a medication prescription 105 from a doctor 107, pharmacies 109 and insurance company 111. In use, the prescription 105 from the doctor 107 to the consumer 103 is taken to the pharmacy 109 that is nearby or where the insurance company 111 will cover the cost associated with the prescription. When filled 113 the cost of the prescription is presented 115 and the consumer pays the cost 115.

One of the problems commonly associated with method 101 is its limited efficiency. For example, the consumer is unaware of the cost of the prescription 105 is not considered when being filled by the consumer 103. It is common for the cost of the medication to not be published, this eliminates the ability of the consumer to find the best price.

Accordingly, although great strides have been made in the area of medication purchasing methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common medication purchasing method;

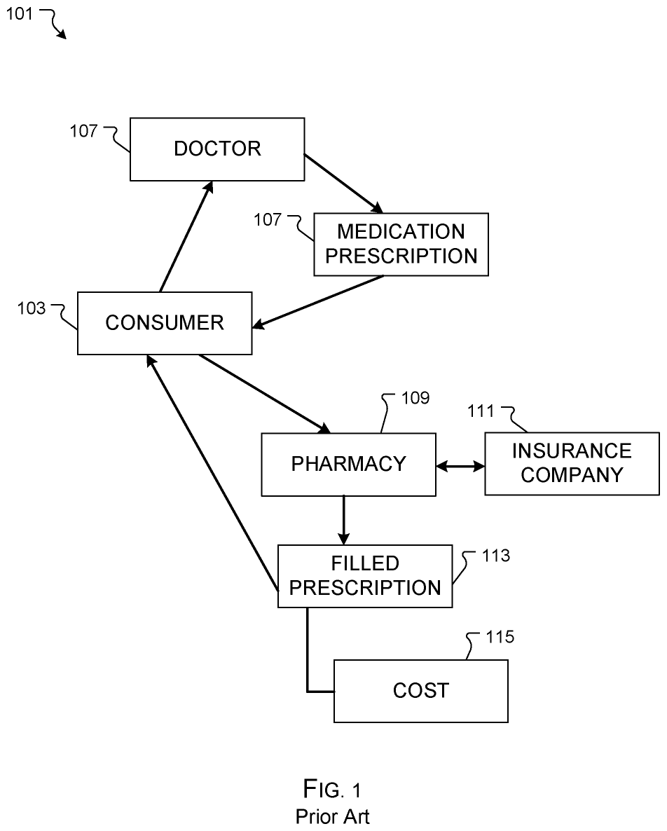

FIG. 2 is a diagram of a prescription location system in accordance with a preferred embodiment of the present application;

FIG. 3 is a diagram of an alternative embodiment of the system of FIG. 2;

FIG. 4 is a flowchart of the preferred method of use of the system of FIG. 2; and

FIG. 5 is a diagram of the estimate of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional medication purchasing methods. Specifically, the invention of the present application enables a consumer to locate sources of the prescribed medication with the lowest cost. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

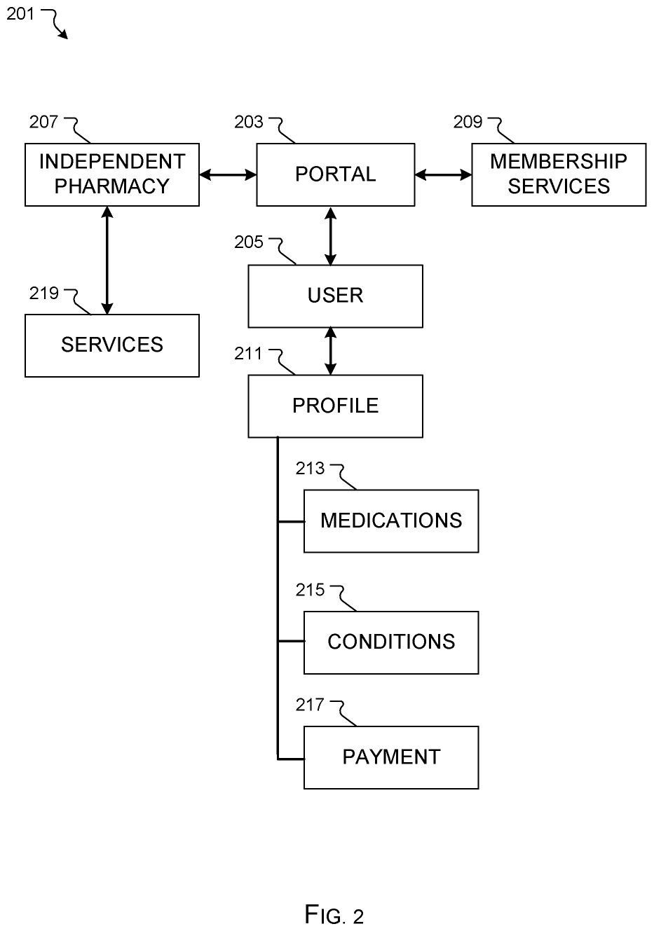

Referring now to the drawings wherein like reference characters identify corresponding or similar elements throughout the several views, FIG. 2 depicts a diagram of a prescription location system in accordance with a preferred embodiment of the present application. It will be appreciated that system 201 overcomes one or more of the above-listed problems commonly associated with conventional medication purchasing method systems.

In the contemplated embodiment, system 201 includes a portal 203 that enables communication between a user 205 and independent pharmacies 207. It is contemplated that his communication occurs through an electronic network or the like. The independent pharmacies 208 provide access to their services 219 via the portal 203. The portal 203 provides access to membership services 209.

The user 205 transmits data in the form of profile 211 to the portal 203. In the contemplated embodiment the profile 211 includes data such as current medications 213 that are taken by the user 205, the medical conditions 215 treated by the medications 213 and a payment 217 history of these medications.

In use, the independent pharmacies 207 review the profile 211 of the user 205 and provide an estimate of the cost of the medications needed. The user 205 reviews the estimates and selects an independent pharmacy 207 to fulfil their medications.

It will be understood that an independent pharmacy 207 is an entity that is not associated with a corporation or other large business. It will further be understood that the costs of the products provided by the independent pharmacies 207 are not commonly available to the public and that this invention allows for competition and diversity within the marketplace.

It should be appreciated that one of the unique features believed characteristic of the present application is that portal 203 places users 205 in communication with independent pharmacies 207 and allows the independent pharmacies 207 to provide estimates or bids on the cost of the medications 213 requested by the user 205.

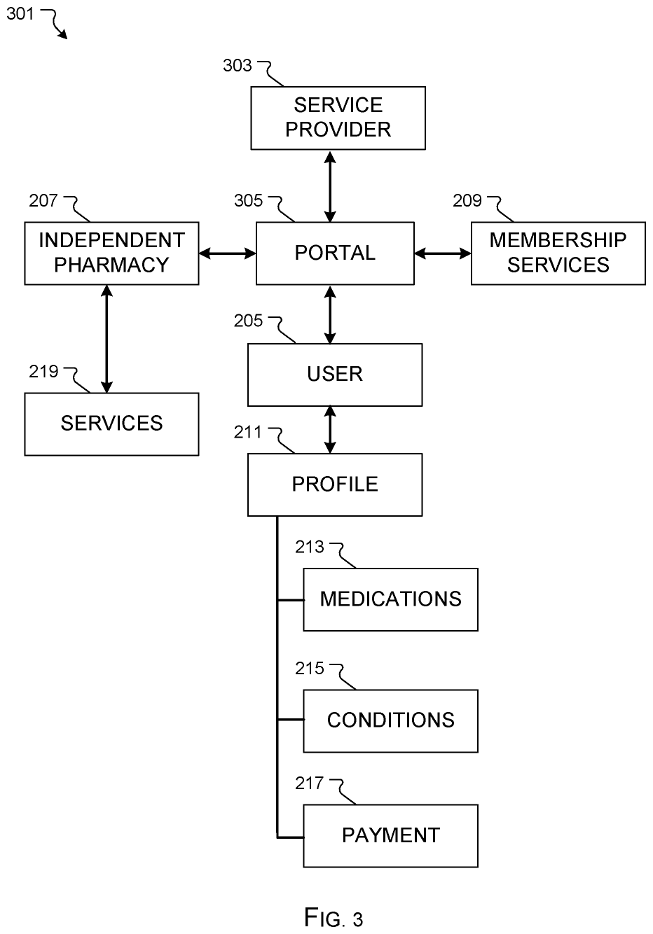

In an alternative embodiment of the system 201 depicted by FIG. 3, similar features are included wherein service providers 303 are in communication with the portal 305. While a key benefit of the independent pharmacies 207 is lower cost, other service providers add depth and competition to the system 301. It is contemplated that a service provider 303 could be any vendor or entity that sells, buys, or renders a service, either to the user 205 or the independent pharmacies 207.

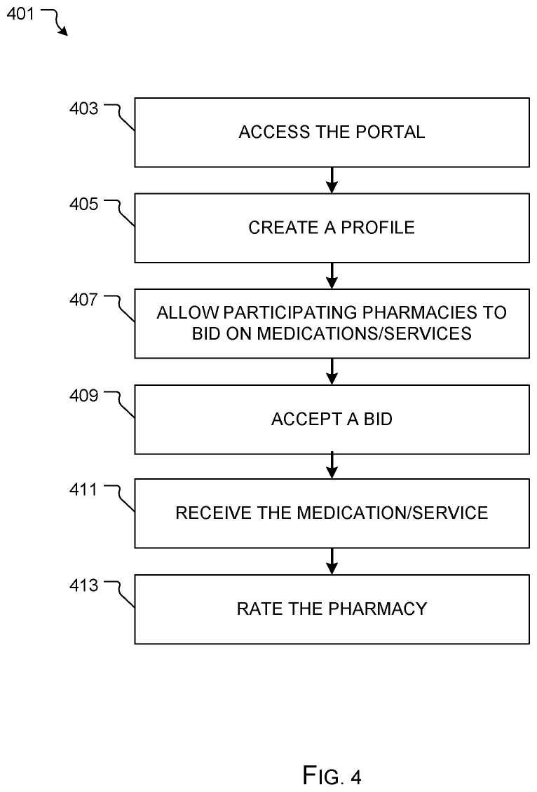

Referring now to FIG. 4 the preferred method of use of the system 201 is depicted. Method 401 includes accessing the portal 403, creating a profile 405, allowing participating pharmacies to bid on the medications or services requested in the profile 407, accepting a bid 409, receiving the medications or services 411 and rating the pharmacy for others to see 413.

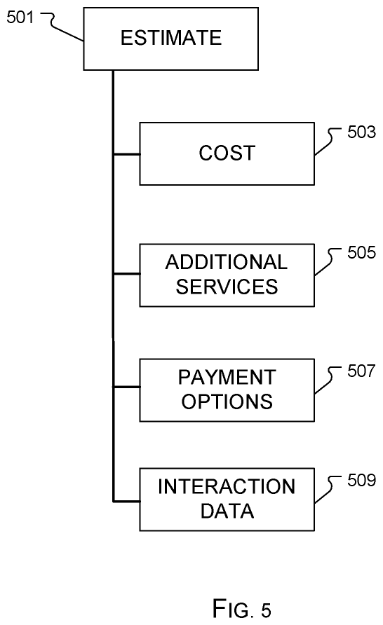

As depicted by FIG. 5 it is contemplated that estimate 501 or bid received by the user 205 includes a cost 503, additional services offered but not requested 505, payment options 507, interaction data 509 or the like and could be more than a simple cost bid.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A prescription location system comprising:
at least one user;
at least one independent pharmacy; and
at least one portal in communication via a network;
wherein the at least one users create a profile with data relevant to at least one medication; and
wherein the at least one independent pharmacies provide an estimate to the at least one users for the medications.

2. The system of claim 1 wherein the at least one independent pharmacies include any vendor or entity providing any product or service related to the fulfilment of the medications or the conditions treated thereby.

3. The system of claim 1 wherein the estimate includes the cost, payment options interaction data or additional services available but not requested.

4. The method of allowing independent pharmacies to bid on medications given the system of claim 1, comprising:
accessing the portal;
creating a profile;
allowing participating pharmacies to bid on the medications or services requested in the profile;
accepting a bid;
receiving the medications or services; and
rating the pharmacy for others to see.
